(19) United States
(12) Patent Application Publication
(10) Pub. No.: US 2012/0152446 A1
(43) Pub. Date: Jun. 21, 2012

(54) METHOD OF INCORPORATING OSCILLATING ELASTIC INTO DISPOSABLE GARMENTS

(76) Inventors: Brian K. Rhodes, Larsen, WI (US); Lacey L. Poole, Appleton, WI (US); Joseph A. Mlinar, Appleton, WI (US); Marlene R. Dins, Appleton, WI (US); Gregory J. Rajala, Neenah, WI (US)

(21) Appl. No.: 12/970,619

(22) Filed: Dec. 16, 2010

(51) Int. Cl. B32B 38/10; B32B 38/04

(52) U.S. Cl. 156/226; 156/250; 156/247

(57) ABSTRACT

A method for manufacturing a composite garment web is disclosed. The method can include attaching elastic members to an elastomeric web, and optionally covering the elastic members with a covering web. One or more of the elastic members define an oscillating pattern. The method embodiment further comprises longitudinally slitting the composite chassis web to split it into body panel webs, and thereafter a bridging panel, such as an absorbent composite, is attached to the body panel webs to bridge the gap therebetween. During the slitting operation, one, both, or none of the elastic members may be slit by the slitter. If a covering panel is present, it may be slit by the slitter. In another aspect, the present invention relates to a method for manufacturing a plurality of pant-like disposable absorbent garments.

### BACKGROUND

People rely on disposable absorbent products in their everyday lives, including such articles as adult incontinence products, enuresis pants, training pants, and diapers. Many manufacturers seek to better meet the needs of users of such products. For example, there is a need to further improve fit, discretion, and leakage protection for many products. With certain products, such as adult incontinence underwear and enuresis pants, it is important that the garment feel as much as possible like “regular” underwear to promote an improved sense of normalcy to the wearer who suffers from incontinence or enuresis. Many conventional pant-like, pull-on style absorbent garments currently on the market employ a product chassis in which multiple threads of elastic are sandwiched between two nonwoven fabric layers. The strands extend around the body, such that the elastic forces extend primarily around the wearer's waist, as is the case with traditional cloth briefs. This design can provide good fit and leakage performance, but has the potential to be further improved in terms of looking and feeling even more like “regular” cloth underwear. In many instances, it is possible to also sandwich leg elastic strands between the nonwoven fabric layers.

One class of materials that offers the potential to make absorbent garments more “underwear-like” is that of elastomeric substrates, such as elastomeric film laminates. Elastomeric film laminates are typically elastomeric films sandwiched between two nonwoven fabric layers. The films provide elastic properties similar to elastic threads, but offer a smoother, more uniform appearance. Some products currently on the market employ such elastomeric laminates, and utilize a “three-piece” pant construction in which front and back body panels are each constructed of an elastomeric film laminate and are connected together via an absorbent insert that extends between them. Such designs, however, can in certain instances introduce a difficulty. It is frequently desirable to include additional elasticization in the product, such as around the leg openings. In certain configurations, it may not be possible to simply sandwich additional leg elastic threads between the two nonwoven layers, such as when the elastomeric film laminate is a “pre-laminated” sandwich of an elastomeric film layer between two nonwoven layers. Instead, the leg elastic threads must be affixed to an outer surface of the elastomeric film laminate. In such instances, it is usually necessary to provide an additional layer of material to seal around the elastic threads and any associated adhesive, thereby holding the elastic threads in place on the elastomeric film laminate. Various efforts have been made to achieve this end, but they have been unsatisfactory. What is needed are improved and cost-effective methods of securing elastics, such as leg elastics, to elastomeric film laminate body panels in the manufacture of disposable absorbent garments, in part to help, in certain instances, simplify and improve the high speed manufacture of such garments.

### SUMMARY OF THE INVENTION

To meet the above-described unmet needs in the art, a new process for making a composite garment web, and a new process for making pant-like disposable garments, and a garment made thereby, have been invented.

In one aspect, the present invention relates to a method for manufacturing a composite garment web. The method defines a longitudinal machine direction and a transverse cross-machine direction. In one embodiment of this aspect of the invention, the method comprises supplying an elastomeric web traveling in the machine direction, the elastomeric web defining first and second edges extending in the machine direction. The elastomeric web defines a slit line extending in the machine direction and positioned transversely between the first and second edges. The method embodiment further comprises supplying a continuous first elastic member and a continuous second elastic member, both elastic members traveling in the machine direction. The method embodiment further comprises attaching the first elastic member to the elastomeric web in a first pattern, and attaching the second elastic member to the elastomeric web in an oscillating second pattern, where the oscillating second pattern defines one period per product pitch. The method embodiment further comprises supplying a continuous elastic covering web traveling in the machine direction, and attaching the elastic covering web to the elastomeric web so as to sandwich both the first and second elastic members between the elastomeric web and the covering web, thereby creating a composite chassis web. The method embodiment further comprises longitudinally slitting the composite chassis web with a slitter along the slit line to split the composite chassis web into a first body panel web and a second body panel web. The method embodiment further comprises moving the first body panel web transversely away from the second body panel web to define a gap therebetween. The method embodiment further comprises attaching a first end of an absorbent composite to the first body panel web and attaching a second end of the absorbent composite to the second body panel web such that the absorbent composite bridges the gap between the first and second body panel webs, thereby defining the composite garment web.

In another aspect, the present invention relates to a method for manufacturing a plurality of pant-like disposable absorbent garments. The method defines a longitudinal machine direction and a transverse cross-machine direction. In one embodiment, the method comprises supplying an elastomeric laminate web traveling in the machine direction and comprising an elastomeric layer and at least one nonwoven layer, the laminate web defining first and second edges extending in the machine direction, and the laminate web defining a slit line extending in the machine direction and positioned transversely between the first and second edges. The method embodiment further comprises supplying a continuous first leg elastic member and a continuous second leg elastic member, both leg elastic members traveling in the machine direction. The method embodiment further comprises attaching the first leg elastic member to the laminate web in a first pattern, and attaching the second leg elastic member to the laminate web in an oscillating second pattern, where the oscillating second pattern defines one period per product pitch. The method embodiment further comprises supplying a continuous leg elastic covering web traveling in the machine direction. The method embodiment further comprises attaching the leg elastic covering web to the laminate web so as to sandwich both the first and second leg elastic members between the laminate web and the covering web, thereby creating a composite chassis web. The method embodiment further comprises longitudinally slitting the composite chassis web with a slitter along the slit line to split the composite chassis web into a first body panel web and a second body panel web. The method embodiment further comprises moving the first body panel web transversely away from the second body panel web to define a gap therebetween. The method embodiment further comprises attaching a first end of an absorbent composite to the first body panel web and attaching a second end of the absorbent composite to the second body panel web such that the absorbent composite bridges the gap between the first and second body panel webs, thereby defining a composite garment web. The method embodiment further comprises folding the composite garment web along a centerline that extends in the machine direction, such that the first edge is brought into close proximity with the second edge. The method embodiment further comprises attaching the first body panel web to the second body panel web along a series of garment side seam bonds spaced apart in the machine direction. The method embodiment further comprises cutting the composite garment web at a series of cut locations spaced apart in the machine direction to create the plurality of pant-like disposable absorbent garments.

In another embodiment, the method comprises supplying an elastomeric laminate web traveling in the machine direction and comprising an elastomeric film layer and at least one nonwoven layer, the laminate web defining first and second edges extending in the machine direction, and the laminate web defining a slit line extending in the machine direction and positioned transversely between the first and second edges. The method embodiment further comprises supplying a continuous first leg elastic member and a continuous second leg elastic member, both leg elastic members traveling in the machine direction. The method embodiment further comprises attaching the first leg elastic member to the laminate web in an oscillating first pattern, wherein the oscillating first pattern defines one-half of a period per product pitch, and wherein the first leg elastic member crosses the slit line once per product pitch. The method embodiment further comprises attaching the second leg elastic member to the laminate web in an oscillating second pattern, where the oscillating second pattern defines one-half of a period per product pitch, and wherein the second leg elastic member crosses the slit line once per product pitch. The method embodiment further comprises supplying a continuous leg elastic covering web traveling in the machine direction. The method embodiment further comprises attaching the leg elastic covering web to the laminate web so as to sandwich both the first and second leg elastic members between the laminate web and the covering web, thereby creating a composite chassis web. The method embodiment further comprises longitudinally slitting the composite chassis web along the slit line by a slitter to split the composite chassis web into a first body panel web and a second body panel web, wherein both the first and second leg elastic members are cut by the slitter at the slit line. The method embodiment further comprises moving the first body panel web transversely away from the second body panel web to define a gap therebetween; attaching a first end of an absorbent composite to the first body panel web and attaching a second end of the absorbent composite to the second body panel web such that the absorbent composite bridges the gap between the first and second body panel webs, thereby defining a composite garment web; folding the composite garment web along a centerline that extends in the machine direction, such that the first edge is brought into close proximity with the second edge; attaching the first body panel web to the second body panel web along a series of garment side seam bonds spaced apart in the machine direction; and cutting the composite garment web at a series of cut locations spaced apart in the machine direction to create the plurality of pant-like disposable absorbent garments.

In another embodiment, the method comprises supplying an elastomeric laminate web traveling in the machine direction and comprising an elastomeric layer and at least one nonwoven layer, the laminate web defining first and second edges extending in the machine direction, and the laminate web defining a slit line extending in the machine direction and positioned transversely between the first and second edges; supplying a continuous first leg elastic member and a continuous second leg elastic member, both leg elastic members traveling in the machine direction; attaching the first leg elastic member to the laminate web in a first pattern; attaching the second leg elastic member to the laminate web in an oscillating second pattern; longitudinally slitting the laminate web with a slitter along the slit line to split the laminate web into a first body panel web and a second body panel web; moving the first body panel web transversely away from the second body panel web to define a gap therebetween; attaching a first end of an absorbent composite to the first body panel web and attaching a second end of the absorbent composite to the second body panel web such that the absorbent composite bridges the gap between the first and second body panel webs, thereby defining a composite garment web; folding the composite garment web along a centerline that extends in the machine direction, such that the first edge is brought into close proximity with the second edge; attaching the first body panel web to the second body panel web along a series of garment side seam bonds spaced apart in the machine direction; and cutting the composite garment web at a series of cut locations spaced apart in the machine direction to create the plurality of pant-like disposable absorbent garments.

In particular embodiments, the present invention can provide an efficient and process friendly technique to cover and hold in place elastic members in pant-style disposable garments that employ elastomeric substrates, such as elastomeric laminates, including, for example, leg elastic members in pant-style disposable absorbent garments that employ elastomeric film laminates, particularly “pre-made” or “pre-laminated” elastomeric film laminates.

### BRIEF DESCRIPTION OF THE FIGURES

FIG. 1 representatively illustrates a top plan view of portions of a manufacturing process incorporating principles of the process aspect of the present invention.

FIG. 2 representatively illustrates a top plan view of portions of an alternative manufacturing process incorporating principles of the process aspect of the present invention.

FIG. 3 representatively illustrates a top plan view of portions of another manufacturing process incorporating principles of the process aspect of the present invention.

FIG. 4 representatively illustrates a top plan view of portions of another manufacturing process incorporating principles of the process aspect of the present invention.

FIG. 5 representatively illustrates a top plan view of portions of another manufacturing process incorporating principles of the process aspect of the present invention.

FIG. 6 representatively illustrated a top plan view of portions of one embodiment of a manufacturing process suitable for use in conjunction with the present invention.

FIG. 7 representatively illustrates a front perspective view of one example of a disposable absorbent garment which may be generated via certain embodiments of the process aspect of the present invention.

### DEFINITIONS

Within the context of this specification, each term or phrase below will include the following meaning or meanings. Additional terms are defined elsewhere in the specification.

“Attached” refers to the joining, adhering, bonding, connecting, or the like, of two elements. Two elements will be considered to be attached together when they are attached directly to one another or indirectly to one another, such as when each is directly attached to intermediate elements.

“Connected” refers to the joining, adhering, bonding, attaching, or the like, of two elements. Two elements will be considered to be connected together when they are connected directly to one another or indirectly to one another, such as when each is directly connected to intermediate elements.

“Disposable” refers to articles which are designed to be discarded after a limited use rather than being laundered or otherwise restored for reuse.

“Disposed,” “disposed on,” and variations thereof are intended to mean that one element can be integral with another element, or that one element can be a separate structure bonded to or placed with or placed near another element.

“Elastic,” “elasticized” and “elasticity” mean that property of a material or composite by virtue of which it tends to recover its original size and shape after removal of a force causing a deformation.

“Elastomeric” refers to a material or composite which can be elongated by at least percent of its relaxed length and which will recover, upon release of the applied force, at least 20 percent of its elongation. It is generally preferred that the elastomeric material or composite be capable of being elongated by at least 100 percent, more preferably by at least 300 percent, of its relaxed length and recover, upon release of an applied force, at least 50 percent of its elongation.

“Integral” is used to refer to various portions of a single unitary element rather than separate structures bonded to or placed with or placed near one another.

“Layer” when used in the singular can have the dual meaning of a single element or a plurality of elements.

“Member” when used in the singular can have the dual meaning of a single element or a plurality of elements.

These terms may be defined with additional language in the remaining portions of the specification.

### DETAILED DESCRIPTION OF EXEMPLARY EMBODIMENTS

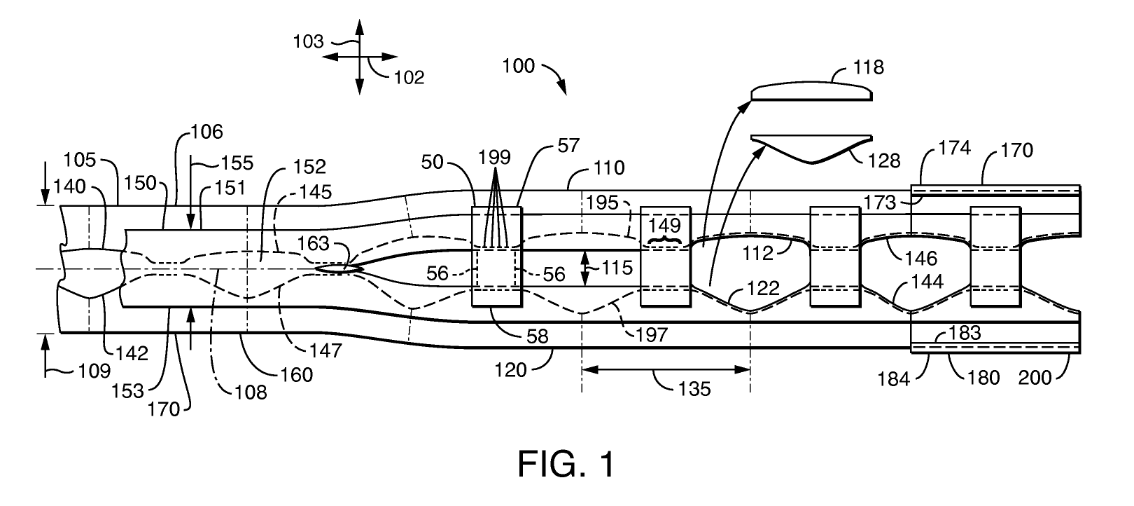

Reference to FIGS. 1-7 shall be made in describing various aspects and embodiments of the invention. It should be noted that the embodiments depicted in FIGS. 1-7 are merely representative examples of the process and product aspects of the invention. Although for illustrative purposes certain features of the present invention shall be described and illustrated with respect to an adult incontinence garment, the various aspects and embodiments of the present invention are also suitable for use with disposable diapers, disposable swim pants, disposable training pants, disposable enuresis garments, and the like. Unless otherwise stated, all length and width dimensions referred to herein contemplate that such dimensions are measured while the garment or web is in a laid-flat condition, and prior to (in the case of garment dimensions) the joining of the front and back regions along side seams. Furthermore, unless otherwise stated, if a length or width measurement varies depending on where the measurement is taken (for example, if a scalloped edge causes a dimension to vary depending on where along the scalloped edge the measurement is taken), the length or width measurement for purposes herein is the maximum length or width that can be measured for that feature.

The present invention relates in certain aspects to techniques to incorporate leg elastic members into pant-like disposable absorbent garments, and to methods for manufacturing a plurality of pant-like disposable absorbent garments employing such techniques. The method 100 aspect of the present invention defines a longitudinally extending machine direction 102 and a transversely extending cross-machine direction 103. In particular embodiments, as representatively illustrated in FIGS. 1-5, the method 100 includes supplying an elastomeric laminate web, such as an elastomeric film laminate web 105, traveling in the machine direction 102. The elastomeric laminate web comprises in particular embodiments at least one elastic layer, and at least one nonwoven or fabric layer. For example, the elastomeric film laminate web 105 comprises an elastomeric film layer and at least one nonwoven layer. Preferably, the elastomeric film layer is sandwiched between two nonwoven layers. U.S. Pat. Nos. 6,969,441, 6,902,796, 5,695,868, 5,837,352, and 5,843,057, and U.S. Patent Application Publications US 2008/0095978 and US 2009/0197041, all assigned to Kimberly-Clark Worldwide, Inc. and incorporated by reference herein to the extent not inconsistent herewith, provide examples of technology suitable for use in creating elastomeric laminates suitable for use with the present invention, although other elastomeric laminates can also be used. In particular embodiments, the elastomeric laminate can be “pre-laminated,” and it is unwound in laminate form. In other embodiments, nonwoven webs and elastic materials (such as elastomeric film webs) are provided separately and mated together directly within the garment manufacturing assembly process. In particular embodiments, the elastomeric web need not be a laminate of multiple layers, but could be, for example, a relatively homogenous matrix having elastomeric properties.

In particular embodiments, the elastomeric film laminate web 105 defines a first edge 106 that extends in the machine direction 102 and a second edge 107 that extends in the machine direction 102. The first edge 106 and the second edge 107 define a laminate web width 109 therebetween. In particular embodiments, the first and second edges 106, 107 define straight lines which are parallel to each other. The laminate web defines a slit line 108 that also extends in the machine direction. As used herein, “slit line” refers to an imaginary line, such as a straight line or a wavy line, along which the laminate web is to be slit during the manufacturing process to separate the laminate web 105 into first and second body panel webs, as shall be described below. As shown in FIGS. 1-5, the slit line 108 is positioned transversely between the laminate web first edge 106 and the laminate web second edge 107. In particular embodiments, the slit line 108 is positioned closer to the first edge 106 than to the second edge 107.

The method in particular embodiments further includes supplying a continuous first elastic member 140 and a continuous second elastic member. In the following exemplary embodiments, the continuous elastic members shall be described in the context of continuous leg elastic members, but it is understood that in application, the elastic members could be waist elastic members, crotch elastic members, or other elastic members with the disposable garment.

In particular embodiments, therefore, the method further includes supplying a continuous first leg elastic member 140 and a continuous second leg elastic member 142, both leg elastic members 140/142 traveling in the machine direction 102. Each leg elastic member 140/142 can comprise a single ribbon, strand, strips, or thread (or the like) of elastic material, or each can comprise two, three, or more ribbons, strands, or threads (or the like) of elastic material. Therefore, the lines 140/142 representing leg elastics in the Figures are each indicative of one, two, three, or more ribbons, strands, or threads. Elastic ribbons, strands, threads, and the like suitable for use in disposable absorbent garments are known in the art, one example being LYCRA brand elastic filaments, available from the Dupont Corporation. In particular embodiments, the method includes supplying only a first leg elastic member (such as, for example, a back leg elastic member), but no second leg elastic member.

The method further includes attaching the first leg elastic member 140 to the laminate web 105 in a first pattern 145, and attaching the second leg elastic member 142 to the laminate web 105 in a second pattern 147. Desirably, as representatively illustrated in FIGS. 1-6, the first leg elastic member 140 is attached to the laminate web 105 such that it is destined to be positioned at least partially adjacent a leg edge 112 of what is to become a first body panel web 110. Similarly, the second continuous leg elastic member 142 is desirably attached to the laminate web 105 such that it is destined to be positioned at least partially adjacent a leg edge 122 of what is to become a second body panel web 120. In certain embodiments, the first leg elastic member 140 extends in the machine direction 102 in a straight-line path, and the second leg elastic member 142 extends in a non-straight-line path in the machine direction 102. In other embodiments, such as that representatively illustrated in FIGS. 1-6, both the first leg elastic member 140 and the second leg elastic member 142 extend in a non-straight-line path in the machine direction 102. For example, in particular embodiments, one of or both of the first leg elastic member 140 and the second leg elastic member 142 can be provided in an oscillating pattern, additional details of which are discussed below.

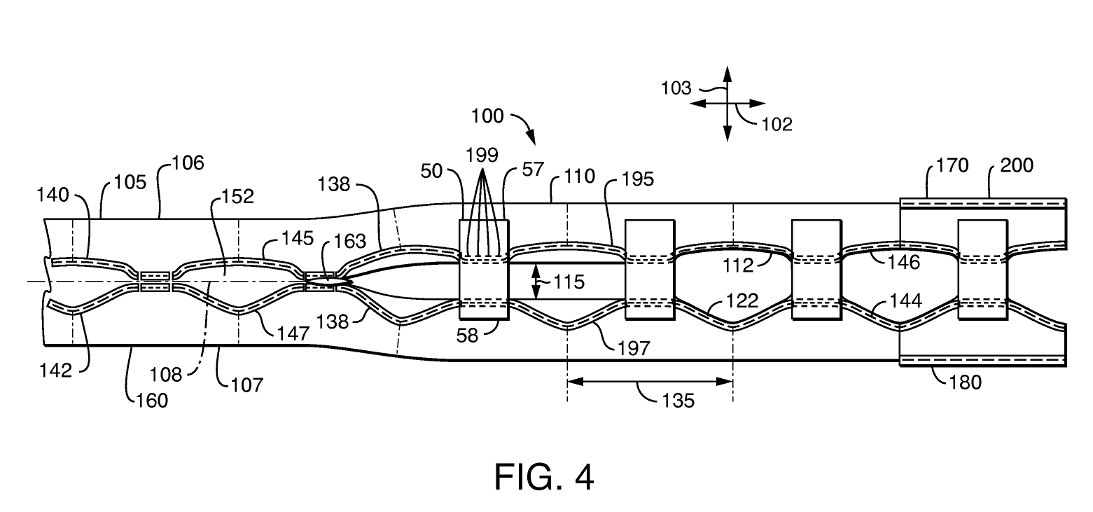

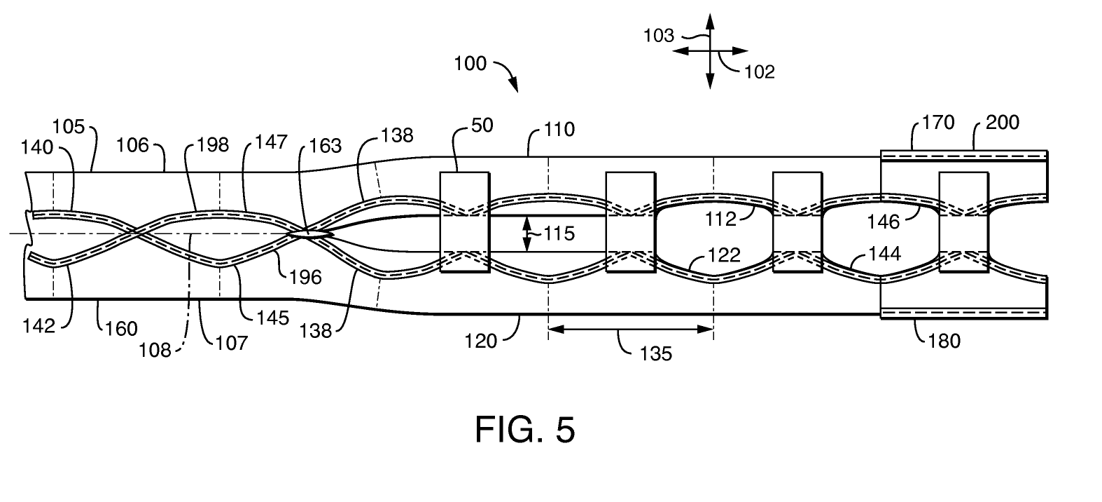

In particular embodiments, one or both of the continuous first and second leg elastic members 140, 142 comprise one or more elastic strands sandwiched between nonwoven ribbon layers 138 (such as by sandwiching elastic strands between two distinct nonwoven webs or by enveloping elastic strands within a single, “C-folded” nonwoven web). Examples of such embodiments are representatively illustrated in FIGS. 4 and 5.

In other embodiments, the method comprises supplying a continuous leg elastic covering web 150 traveling in the machine direction 102. The leg elastic covering web 150 may comprise, for example, any suitable nonwoven material, such as spunbond, spunbond-meltblown laminates, bonded-carded webs, and the like. In particular embodiments, such as that representatively illustrated in FIGS. 1-3, the leg elastic covering web 150 defines a first edge 151, a second edge 153, and a width 155 extending between the first edge 151 and the second edge 153 in the cross-machine direction. The first edge 151 and/or the second edge 153 may be straight or non-straight, such as curved. In certain embodiments, the covering web width 155 is approximately equal to the laminate web width 109. In other embodiments, such as those representatively illustrated in FIGS. 1-5, the covering web width 155 is less than the laminate web width 109. After superposing the leg elastic covering web 150 over (or under) the laminate web 105, the method further comprises attaching the leg elastic covering web 150 to the laminate web 105 (such as with adhesive, heat, pressure, or ultrasonic bonding) so as to sandwich the first leg elastic member 140 between the laminate web 105 and the leg elastic covering web 150 and so as to sandwich the second leg elastic member 142 between the laminate web 105 and the leg elastic covering web 150, thereby creating a composite chassis web 160. The composite chassis web 160 defines a composite chassis web width 162 which extends in the cross-machine direction 103, which is the width between the two transversely outermost edges of the composite process web assembly. In particular embodiments, the composite chassis web width 162 is greater than the cross-machine direction width 155 of the leg elastic covering web 150.

In particular embodiments, the method can comprise supplying a first waistband web 170 and a second waistband web 180 and can further comprise attaching the first waistband web 170 to the laminate web 105 and attaching the second waistband web 180 to the laminate web 105. The waistband webs can be inherently elastomeric (such as via the use of an elastomeric film laminate material). Alternatively, waist elastic strands could be affixed to the front and/or back waistband webs to impart elasticity thereto. For example, the waistband webs could be inherently non-elastomeric but made to be elastomeric by affixing elastic strands thereto (such as by sandwiching elastic strands between two nonwoven webs or by enveloping elastic strands within a single, “C-folded” nonwoven web). Each first elastic waistband web 170 defines a proximal edge 173 and a distal edge 174, and each second waistband web defines a proximal edge 183 and a distal edge 184. In embodiments that include waistband webs applied before the laminate web 105 is slit and split into front and back body panel webs (not shown), the width 162 of the composite chassis web 160 is the width extending in the cross-machine direction between the first waistband web distal edge 174 and the second waistband web distal edge 184.

The method 100 further includes slitting the composite chassis web 160 with a slitter 163 along the slit line 108 to split the composite chassis web 160 into a first body panel web 110 and a second body panel web 120. Slitters suitable for slitting nonwoven materials at high speed are known in the art, examples being rotary knives, stationary knives, die cutters, and water cutters. The method further includes moving the first body panel web 110 transversely away from the second body panel web 120 to define a gap 115 between them.

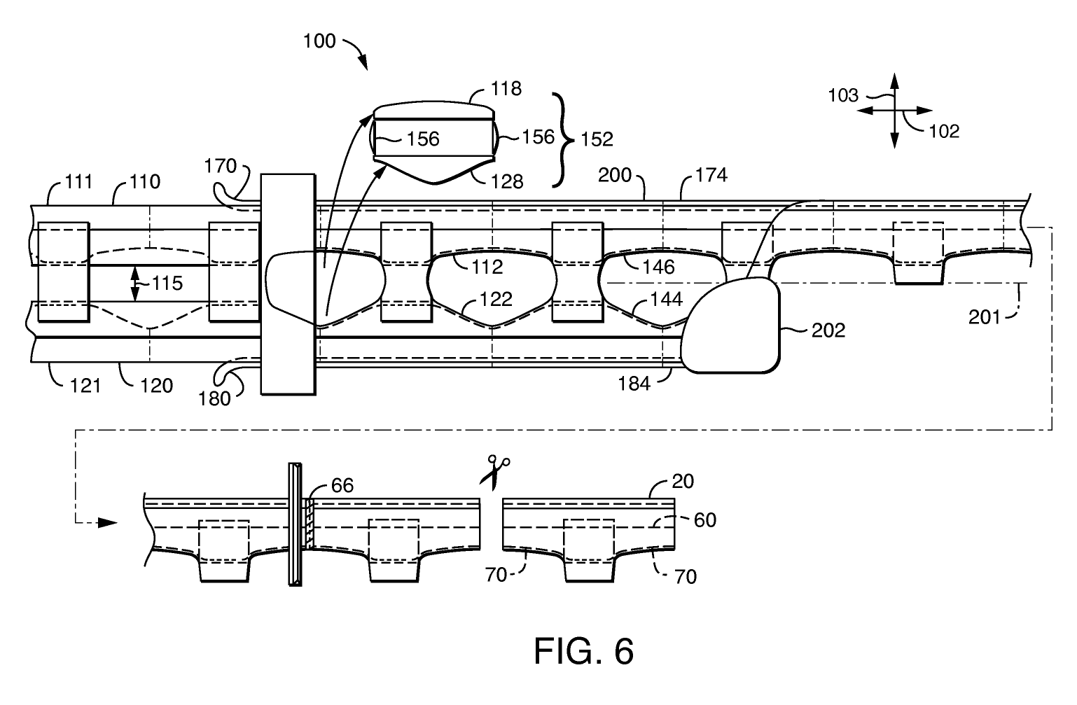

The method can in particular embodiments further comprise removing portions 152 of the leg elastic covering web 150 and/or of the laminate web 105. For example, the method can comprise removing portions 128 of the second body panel web 120, removing portions 118 of the first body panel web 110, or removing both portions 128 of the second body panel web 120 and portions 118 of the first body panel web 110. Removal of portions 128 of the second body panel web 120 defines a series of back leg opening edges 144 spaced apart in the machine direction 102. Similarly, removal of portions 118 of the first body panel web 110 defines a series of front leg opening edges 146 spaced apart in the machine direction 102. It can be seen that in the examples representatively illustrated in FIGS. 1-3, the removed portion 118 of the first body panel web includes portions of both the laminate web 105 and the covering web 150, and the removed portion 128 of the second body panel web includes portions of both the laminate web 105 and the covering web 150. In particular embodiments, such as those representatively illustrated in FIGS. 1-6, portions 118/128 are removed after the composite chassis web 160 has been slit by the slitter 163. In other embodiments, portions 152 of the laminate web 105 and/or the covering web 150 are removed to define front and/or back leg edges before the composite chassis web 160 has been slit by the slitter 163. In addition or in the alternative to removal of portions 118/128 of the front and/or back body panel webs, particular embodiments of the method can include removing portions 156 of the absorbent composite 50 (discussed below) to define a series of crotch edges 148 spaced apart in the machine direction 102. Such an embodiment is representatively illustrated in FIG. 6. Note that in such an embodiment, the removed portions 152 include a removed portion 118 of the first body panel web 110, a removed portion 128 of the second body panel web 120, and removed portions 156 of the absorbent composite 50. Removal of the various portions can be accomplished by known techniques, such as via a die cutter unit. In particular embodiments, one or more continuous ribbons of the laminate web 105 and/or of the covering web 150 may be trimmed and removed during the slitting step (not shown).

The method 100 in particular embodiments can further comprise providing a supply of absorbent composites 50. In particular embodiments, each absorbent composite 50 comprises a liquid impermeable barrier layer, an absorbent core comprised of liquid-absorbing materials such as cellulosic fluff and/or superabsorbent polymer, a liquid permeable bodyside liner, and crotch elastic members 56. The method can further comprise attaching a first end 57 of each absorbent composite 50 to the first body panel web 110, and attaching a second end 58 of each absorbent composite 50 to the second body panel web 120, such that the absorbent composites 50 are spaced apart in the machine direction. In this way, each absorbent composite 50 bridges the gap 115 between the first and second body panel webs 110, 120. The series of absorbent composites 50 and the front and back body panel webs 110, 120 (which include the leg elastic members 140, 142, and may optionally include waistband webs 170, 180), together define a composite garment web 200. As representatively illustrated in FIG. 6, the method 100 further includes folding the composite garment web 200 along a centerline 201 that extends in the machine direction 102 (such as at folding station 202), such that the first body panel web waist edge 111 is brought into close proximity with the second body panel web waist edge 121, and/or such that the first waistband web distal edge 174 is brought into close proximity with the second waistband web distal edge 184. The method in particular embodiments further includes attaching the first body panel web 110 to the second body panel web 120 along a series of garment side seam bonds 66 spaced apart in the machine direction 102. The method further includes cutting the composite garment web 200 at a series of cut locations spaced apart in the machine direction 102 to create the plurality of pant-like disposable absorbent garments 20. The seaming and cutting operations can occur at separate stations, or can occur at a single seaming and cutting station 166. The garment side seam bonds 66 produce in the final garment a pair of side seams 84, 84 which connect the front region 30 of the garment 20 to the back region 34 of the garment 20, such that the garment 20 defines a waist opening 27 and a pair of leg openings 28. The side seams can be permanent but tearable, such as by way of adhesive, thermal, or ultrasonic bonding, or can be more readily releasable as well as refastenable, such as via the use of mechanical fastening elements.

In certain embodiments, it may be desirable to reduce or eliminate the ability of the elastic strands to impart gathering forces in selected regions of an absorbent garment by relieving the elastic strands of tension in selected regions. For example, if it is desired to reduce or eliminate the gathering force of the elastic strands in the laterally central region of the garment (such as over the absorbent composite 50), the elastic strands may be severed, such as via a leg elastic cutter, so that the elastic strands “snap back” a selected distance and such that the elastic strands do not pass over the laterally central region of the garment. A channel which is devoid of adhesive may be formed between the laminate web 105 and the covering web 150 to allow such “snap back” to occur. In another example, the elastic members may be chopped into several small segments 199, such as a via a leg elastic chopper, so that the elastic strands are substantially devoid of elastic force in the laterally central region of the garment, such as the portion 149 that ultimately passes over the absorbent composite 50; such configuration is depicted in FIGS. 1-6. Examples of techniques to reduce or eliminate the gathering or contractive force of the leg elastic strands in the laterally central region of the garment are disclosed in U.S. Pat. No. 5,745,922 and U.S. Pat. No. 5,660,657, both to Rajala et al, the entirety of which are hereby incorporated by reference to the extent consistent herewith. In other embodiments, in which the leg elastic is comprised of elastic film strips, the retractive force of the strips could be reduced or eliminated via the use of heat, pressure, ultrasonic energy, a combination thereof, or other techniques.

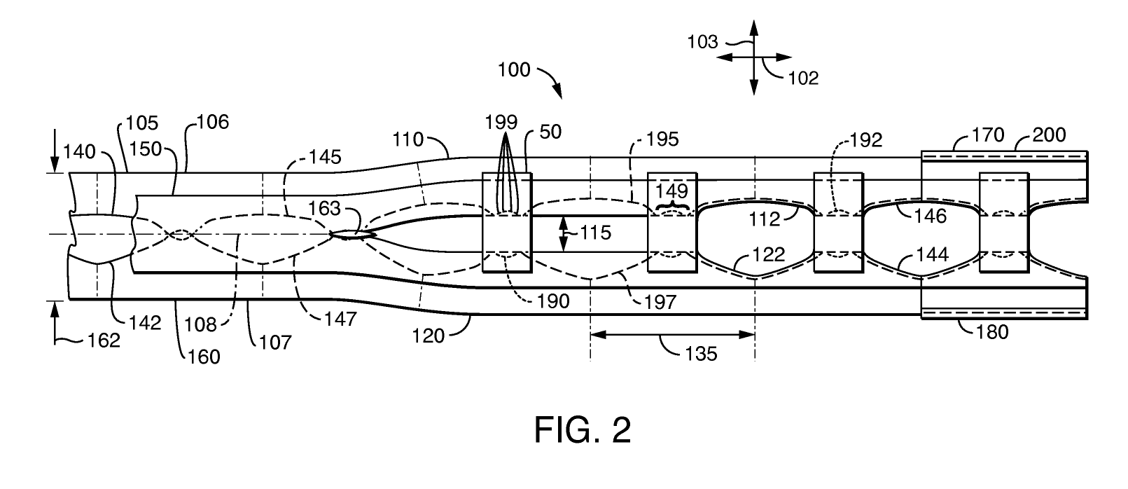

Returning to the leg elastic patterns 145/147, in particular embodiments, such as those representatively illustrated in FIGS. 1, 2, 4, and 6, an oscillating first pattern 145 of the first continuous leg elastic member 140 defines one period 195 per product pitch 135, and/or an oscillating second pattern 147 of the second continuous leg elastic member 142 defines one period 197 per product pitch 135. “Product Pitch” means the distance in the machine direction at any longitudinal location in the process between identical reference points on two adjacent products, and is a term well understood by those of skill in the art. In some variants of such embodiments, at least one of the continuous first leg elastic member 140 and the continuous second leg elastic member 142 does not at any point cross the slit line 108. In certain variants, such as that representatively illustrated in FIGS. 1 and 4, neither the first leg elastic 140 nor the second leg elastic 142 crosses the slit line 108. In other variants, only one of the first and second leg elastic members 140, 142 crosses the slit line 108. In still other variants, such as that representatively illustrated in FIG. 2, both the first leg elastic member 140 and the second leg elastic member 142 cross the slit line 108.

In particular embodiments, the first leg elastic member 140 crosses the slit line twice per product pitch 135, and the first leg elastic member 140 is cut by the slitter 163 at the slit line 108, which in particular embodiments may leave a residual piece 190 of the first leg elastic member 140. Similarly, in particular embodiments, the second leg elastic member 142 crosses the slit line twice per product pitch 135, and the second leg elastic member 142 is cut by the slitter 163 at the slit line 108, which in particular embodiments may leave a residual piece 192 of the second leg elastic member. In particular embodiments, such as that representatively illustrated in FIG. 2, both the first leg elastic member 140 and the second leg elastic member 142 cross the slit line twice per product pitch 135, and both the first leg elastic member 140 and the second leg elastic member 142 are cut by the slitter 163 at the slit line 108. If one or more residual pieces are present, it may be desirable to relieve such residual pieces of tension using any of the techniques noted earlier. In particular embodiments, such as that representatively illustrated in FIG. 2, the first and second leg elastic members 140, 142 intersect each other twice per product pitch 135 in close proximity to the slit line 108. In such embodiments, one of or both of the first and second leg elastic members 140, 142 are cut by the slitter at the slit line.

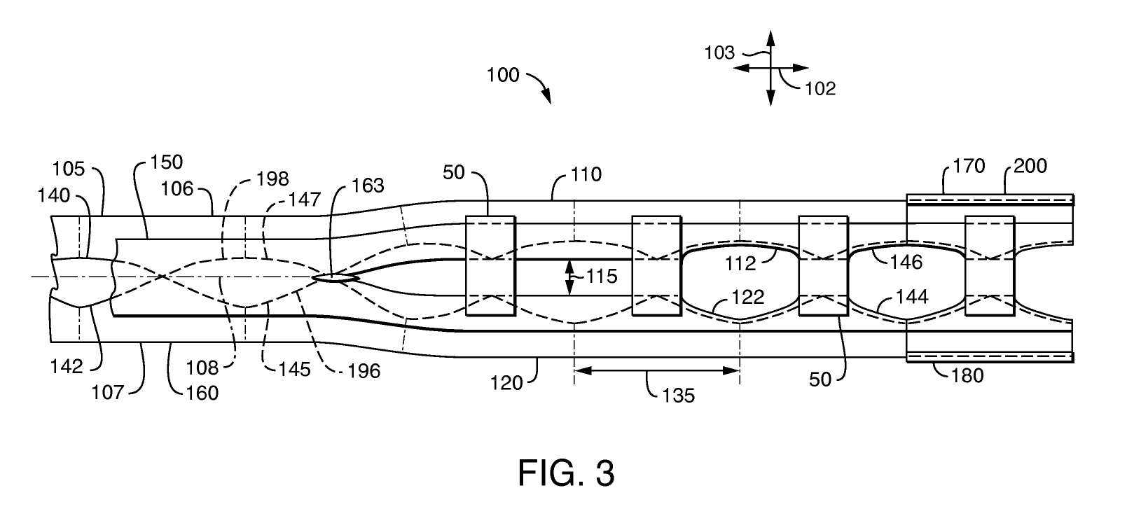

In an alternative embodiment of the method 100, such as that representatively illustrated in FIGS. 3 and 5, the oscillating first pattern 145 of the continuous first leg elastic member 140 defines one-half of a period 196 per product pitch 135, and the first leg elastic member 140 crosses the slit line 108 once per product pitch 135. In other words, each full period 196 of the first leg elastic oscillating pattern 145 extends over two full product pitches. In such embodiments, the first leg elastic member 140 is cut by the slitter 163 at the slit line 108. Additionally or in the alternative, the oscillating second pattern 147 of the continuous second leg elastic member 142 defines one-half of a period 198 per product pitch 135, and the second leg elastic member 142 crosses the slit line 108 once per product pitch 135. In other words, each full period 198 of the second leg elastic oscillating pattern 147 extends over two full product pitches. In such embodiments, the second leg elastic member 142 is cut by the slitter 163 at the slit line 108. In embodiments such as those described in this paragraph, the first leg elastic member 140 would, within each garment 20, form in particular embodiments the front leg elastic 70 on one side of the final garment, and form the back leg elastic 75 on the opposite side of the final garment. The same would in particular embodiments be true of the second leg elastic member 142.

Each garment 20 produced by the various embodiments of the method of the present invention defines a longitudinal direction 22 and a lateral direction 23 perpendicular to the longitudinal direction 22. As used in describing the various embodiments of the garment aspect of the present invention, the longitudinal direction 22 is generally parallel to a vertical plane that bisects a standing wearer into left and right body halves when the article is worn, and the lateral direction 23 is generally perpendicular to the longitudinal direction 22. The garment 20 has a front region 30 defining a front waist end edge 32, a back region 34 defining a back waist end edge 36, and a crotch region 38 positioned longitudinally between the front region 30 and the back region 34.

The garment 20 includes an elastomeric film laminate front panel 40 which defines a front panel waist edge 42, a front panel leg edge 44 spaced longitudinally inward from the front panel waist edge 42, and first and second laterally opposed front panel side edges which extend longitudinally between the front panel waist edge 42 and the front panel leg edge 44. The garment 20 also includes an elastomeric film laminate back panel 41 which defines a back panel waist edge 43, a back panel leg edge 45 spaced longitudinally inward from the back panel waist edge 43, and first and second laterally opposed back panel side edges which extend longitudinally between the back panel waist edge 43 and the back panel leg edge 45. “Longitudinally inward” as used to describe garment embodiments herein means in a direction longitudinally toward a central lateral axis when the article is in a laid-flat condition prior to the joining of the front and back regions via side seams. The front panel 40 is longitudinally spaced apart from the back panel 41. Examples of suitable elastomeric film laminates are discussed above in conjunction with the method aspect of the invention. In preferred embodiments, both the elastomeric film laminate front panel 40 and the elastomeric film laminate back panel 41 comprise an elastomeric film layer sandwiched between two nonwoven facing layers.

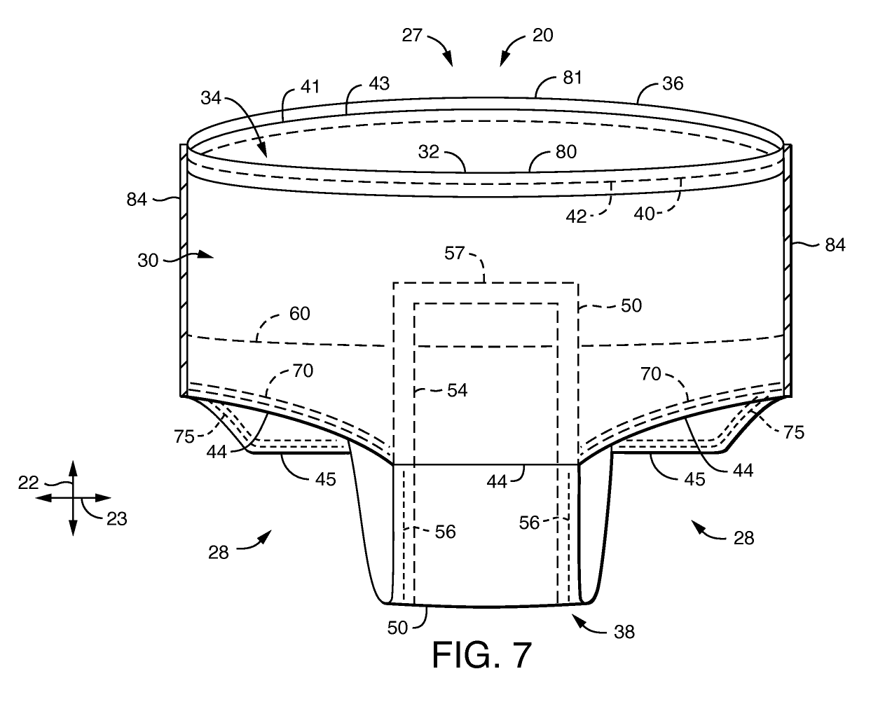

The garment further includes at least one front leg elastic member 70 disposed adjacent the front panel leg edge 44, and at least one back leg elastic member 75 disposed adjacent the back panel leg edge 45. Examples of suitable leg elastic materials are discussed above in conjunction with the method aspect of the invention. In particular embodiments, the back leg elastic member 75 and/or the front leg elastic member 70 extends laterally across the entire garment width. In other embodiments, such as that representatively illustrated in FIG. 7, the back leg elastic member 75 can comprise a pair of back leg elastic members, such as first and second back leg elastic members positioned on opposite sides of the absorbent composite 50. Similarly, the front leg elastic member 70 can comprise a pair of front leg elastic members, such as first and second front leg elastic members positioned on opposite sides of the absorbent composite 50. In preferred embodiments, such as that representatively illustrated in FIGS. 4 and 5, each back leg elastic member 75 can comprise a plurality of elastomeric threads, and/or each front leg elastic member 70 can comprise a plurality of elastomeric threads.

It will be appreciated that details of the foregoing embodiments, given for purposes of illustration, are not to be construed as limiting the scope of this invention. Although only a few exemplary embodiments of this invention have been described in detail, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

1. A method for manufacturing a composite garment web, the method defining a longitudinal machine direction and a transverse cross-machine direction, the method comprising:
supplying an elastomeric web traveling in the machine direction, the elastomeric web defining first and second edges extending in the machine direction, and the elastomeric web defining a slit line extending in the machine direction and positioned transversely between the first and second edges;
supplying a continuous first elastic member and a continuous second elastic member, both elastic members traveling in the machine direction;
attaching the first elastic member to the elastomeric web in a first pattern;
attaching the second elastic member to the elastomeric web in an oscillating second pattern, wherein the oscillating second pattern defines one period per product pitch;
supplying a continuous elastic covering web traveling in the machine direction;
attaching the elastic covering web to the elastomeric web so as to sandwich both the first and second elastic members between the elastomeric web and the covering web, thereby creating a composite chassis web;
longitudinally slitting the composite chassis web with a slitter along the slit line to split the composite chassis web into a first body panel web and a second body panel web;
moving the first body panel web transversely away from the second body panel web to define a gap therebetween; and
attaching a first end of an absorbent composite to the first body panel web and attaching a second end of the absorbent composite to the second body panel web such that the absorbent composite bridges the gap between the first and second body panel webs, thereby defining the composite garment web.

2. The method of claim 1, wherein the first pattern is an oscillating first pattern, wherein the oscillating first pattern defines one period per product pitch.

3. The method of claim 1, further comprising removing portions of the elastic covering web and portions of the elastomeric web to define a series of back leg opening edges spaced apart in the machine direction.

4. The method of claim 3, wherein said removing occurs after said slitting.

5. The method of claim 1, further wherein the first elastic member is relieved of tension in a region of the first body panel web superposed by the absorbent composite.

6. The method of claim 1, wherein neither the first elastic member nor the second elastic member crosses the slit line.

7. The method of claim 1, wherein the second elastic member crosses the slit line twice per product pitch, and wherein the second elastic member is cut by the slitter at the slit line.

8. The method of claim 1, wherein the first and second elastic members intersect each other twice per product pitch in close proximity to the slit line, and wherein both the first and second elastic members are cut by the slitter at the slit line.

9. The method of claim 1, wherein a transverse width of the covering web is less than a transverse width of the elastomeric web.

10. The method of claim 1, wherein the elastomeric web comprises an elastomeric film layer sandwiched between two nonwoven layers.

11. A method for manufacturing a plurality of pant-like disposable absorbent garments, the method defining a longitudinal machine direction and a transverse cross-machine direction, the method comprising:
supplying an elastomeric laminate web traveling in the machine direction and comprising an elastomeric layer and at least one nonwoven layer, the laminate web defining first and second edges extending in the machine direction, and the laminate web defining a slit line extending in the machine direction and positioned transversely between the first and second edges;
supplying a continuous first leg elastic member and a continuous second leg elastic member, both leg elastic members traveling in the machine direction;
attaching the first leg elastic member to the laminate web in a first pattern;
attaching the second leg elastic member to the laminate web in an oscillating second pattern, wherein the oscillating second pattern defines one period per product pitch;
supplying a continuous leg elastic covering web traveling in the machine direction;
attaching the leg elastic covering web to the laminate web so as to sandwich both the first and second leg elastic members between the laminate web and the covering web, thereby creating a composite chassis web;
longitudinally slitting the composite chassis web with a slitter along the slit line to split the composite chassis web into a first body panel web and a second body panel web;
moving the first body panel web transversely away from the second body panel web to define a gap therebetween;
attaching a first end of an absorbent composite to the first body panel web and attaching a second end of the absorbent composite to the second body panel web such that the absorbent composite bridges the gap between the first and second body panel webs, thereby defining a composite garment web;
folding the composite garment web along a centerline that extends in the machine direction, such that the first edge is brought into close proximity with the second edge;
attaching the first body panel web to the second body panel web along a series of garment side seam bonds spaced apart in the machine direction; and
cutting the composite garment web at a series of cut locations spaced apart in the machine direction to create the plurality of pant-like disposable absorbent garments.

12. The method of claim 11, wherein the first pattern is an oscillating first pattern, wherein the oscillating first pattern defines one period per product pitch.

13. The method of claim 12, further comprising removing portions of the leg elastic covering web and portions of the laminate web to define a series of back leg opening edges spaced apart in the machine direction.

14. The method of claim 13, wherein said removing occurs after said slitting.

15. The method of claim 11, further wherein the first leg elastic member is relieved of tension in a region of the first body panel web superposed by the absorbent composite.

16. The method of claim 11, wherein neither the first leg elastic member nor the second leg elastic member crosses the slit line.

17. The method of claim 11, wherein the second leg elastic member crosses the slit line twice per product pitch, and wherein the second leg elastic member is cut by the slitter at the slit line.

18. The method of claim 11, wherein the first and second leg elastic members intersect each other twice per product pitch in close proximity to the slit line, and wherein both the first and second leg elastic members are cut by the slitter at the slit line.

19. The method of claim 11, wherein a transverse width of the covering web is less than a transverse width of the laminate web.

20. The method of claim 11, wherein the elastomeric laminate web comprises an elastomeric film layer sandwiched between two nonwoven layers.

21. A method for manufacturing a plurality of pant-like disposable absorbent garments, the method defining a longitudinal machine direction and a transverse cross-machine direction, the method comprising:
supplying an elastomeric laminate web traveling in the machine direction and comprising an elastomeric film layer and at least one nonwoven layer, the laminate web defining first and second edges extending in the machine direction, and the laminate web defining a slit line extending in the machine direction and positioned transversely between the first and second edges;
supplying a continuous first leg elastic member and a continuous second leg elastic member, both leg elastic members traveling in the machine direction;
attaching the first leg elastic member to the laminate web in an oscillating first pattern, wherein the oscillating first pattern defines one-half of a period per product pitch, and wherein the first leg elastic member crosses the slit line once per product pitch;
attaching the second leg elastic member to the laminate web in an oscillating second pattern, wherein the oscillating second pattern defines one-half of a period per product pitch, and wherein the second leg elastic member crosses the slit line once per product pitch;
supplying a continuous leg elastic covering web traveling in the machine direction;
attaching the leg elastic covering web to the laminate web so as to sandwich both the first and second leg elastic members between the laminate web and the covering web, thereby creating a composite chassis web;
longitudinally slitting the composite chassis web along the slit line by a slitter to split the composite chassis web into a first body panel web and a second body panel web, wherein both the first and second leg elastic members are cut by the slitter at the slit line;
moving the first body panel web transversely away from the second body panel web to define a gap therebetween;
attaching a first end of an absorbent composite to the first body panel web and attaching a second end of the absorbent composite to the second body panel web such that the absorbent composite bridges the gap between the first and second body panel webs, thereby defining a composite garment web;
folding the composite garment web along a centerline that extends in the machine direction, such that the first edge is brought into close proximity with the second edge;
attaching the first body panel web to the second body panel web along a series of garment side seam bonds spaced apart in the machine direction; and
cutting the composite garment web at a series of cut locations spaced apart in the machine direction to create the plurality of pant-like disposable absorbent garments.

22. The method of claim 21, further comprising removing portions of the leg elastic covering web and portions of the second body panel web to define a series of back leg opening edges spaced apart in the machine direction.

23. The method of claim 21, further wherein the first leg elastic member is relieved of tension in a region of the first body panel web superposed by the absorbent composite, and wherein the second leg elastic member is relieved of tension in a region of the second body panel web superposed by the absorbent composite.

24. The method of claim 21, wherein the elastomeric laminate web comprises an elastomeric film layer sandwiched between two nonwoven layers.

25. A method for manufacturing a plurality of pant-like disposable absorbent garments, the method defining a longitudinal machine direction and a transverse cross-machine direction, the method comprising:
supplying an elastomeric laminate web traveling in the machine direction and comprising an elastomeric layer and at least one nonwoven layer, the laminate web defining first and second edges extending in the machine direction, and the laminate web defining a slit line extending in the machine direction and positioned transversely between the first and second edges;
supplying a continuous first leg elastic member and a continuous second leg elastic member, both leg elastic members traveling in the machine direction;
attaching the first leg elastic member to the laminate web in a first pattern;
attaching the second leg elastic member to the laminate web in an oscillating second pattern;
longitudinally slitting the laminate web with a slitter along the slit line to split the laminate web into a first body panel web and a second body panel web;
moving the first body panel web transversely away from the second body panel web to define a gap therebetween;
attaching a first end of an absorbent composite to the first body panel web and attaching a second end of the absorbent composite to the second body panel web such that the absorbent composite bridges the gap between the first and second body panel webs, thereby defining a composite garment web;
folding the composite garment web along a centerline that extends in the machine direction, such that the first edge is brought into close proximity with the second edge;
attaching the first body panel web to the second body panel web along a series of garment side seam bonds spaced apart in the machine direction; and
cutting the composite garment web at a series of cut locations spaced apart in the machine direction to create the plurality of pant-like disposable absorbent garments.

26. The method of claim 25, wherein the oscillating second pattern defines one period per product pitch.

27. The method of claim 26, wherein the first pattern is an oscillating first pattern, wherein the oscillating first pattern defines one period per product pitch.

28. The method of claim 27, wherein neither the first leg elastic member nor the second leg elastic member crosses the slit line.

29. The method of claim 27, wherein the first and second leg elastic members intersect each other twice per product pitch in close proximity to the slit line, and wherein both the first and second leg elastic members are cut by the slitter at the slit line.

30. The method of claim 26, wherein the second leg elastic member crosses the slit line twice per product pitch, and wherein the second leg elastic member is cut by the slitter at the slit line.

31. The method of claim 25, wherein the first pattern is an oscillating first pattern, wherein the oscillating first pattern defines one-half of a period per product pitch and wherein the first leg elastic member crosses the slit line once per product pitch, further wherein the oscillating second pattern defines one-half of a period per product pitch and wherein the second leg elastic member crosses the slit line once per product pitch,
wherein both the first and second leg elastic members are cut by the slitter at the slit line.

32. The method of claim 25, further comprising removing portions of the second body panel web to define a series of back leg opening edges spaced apart in the machine direction.

33. The method of claim 25, further wherein the first leg elastic member is relieved of tension in a region of the first body panel web superposed by the absorbent composite.

34. The method of claim 33, wherein the second leg elastic member is relieved of tension in a region of the second body panel web superposed by the absorbent composite.

35. The method of claim 25, wherein the elastomeric laminate web comprises an elastomeric film layer sandwiched between two nonwoven layers.

36. The method of claim 25, wherein both leg elastic members comprise at least one elastic strand sandwiched between nonwoven ribbon layers.

37. The method of claim 25, wherein both leg elastic members comprise elastomeric film ribbons.

38. The method of claim 25, comprising longitudinally slitting the laminate web along two slit lines to define a trim web positioned transversely between the two slit lines.

39. The method of claim 25, each absorbent composite further including crotch elastics extending generally in the cross-machine direction of the method.
